(19) United States
(12) Patent Application Publication
(10) Pub. No.: US 2009/0160999 A1
(43) Pub. Date: Jun. 25, 2009

(54) Sensor module, electronic information device, autofocus controlling method, control program and readable recording medium

(75) Inventor: Hidetoshi Nishimura, Ikoma-gun (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/317,027

(22) Filed: Dec. 17, 2008

(30) Foreign Application Priority Data
Dec. 20, 2007 (JP) 2007-329380

(51) Int. Cl. G03B 13/00

(52) U.S. Cl. 348/345; 348/E05.03

(57) ABSTRACT

A sensor module according to the present invention includes an autofocus control section for moving the lens section in a predetermined direction from a reference point to a plurality of predetermined moving points consecutively by the driving section, calculating a focal point evaluation value, which increases as a lens is focused, for every moving point from image information based on an image signal from the image capturing element, obtaining a peak point that corresponds to a peak value of each calculated focal point evaluation value, and subsequently, returning the lens section once to the reference point, and move the lens section in the predetermined direction from the returned reference point to the peak point.

This nonprovisional application claims priority under 35 U.S.C. §119(a) to Patent Application No. 2007-329380 filed in Japan on Dec. 20, 2007, the entire contents of which are hereby incorporated by reference.

### BACKGROUND OF THE INVENTION

1. Field of the Invention

The present invention relates to a sensor module for moving a focusing lens and performing autofocusing to form an image of a subject light on an image capturing chip attached on a substrate; an autofocus controlling method for performing an autofocus control of a focusing lens of the sensor module; an electronic information device, such as a digital camera (e.g., digital video camera and digital still camera), an image input camera (e.g., car-mounted camera, entrance monitoring camera), a scanner, a facsimile machine, a camera-equipped cell phone device, a personal digital assistant (PDA) and a card camera, including the sensor module as an image input device used in an image capturing section of the electronic information device thereof; a control program including a process step recorded therein for allowing a computer to execute each step of the autofocus controlling method; and a readable recording medium, which is computer-readable, including the control program stored therein.

2. Description of the Related Art

A conventional sensor module of this type is mainly used for a camera-equipped cell phone device, a personal digital assistant (PDA), and a card camera. Such a sensor module is provided with, on a substrate of ceramics, glass including epoxy resin and the like, a solid-state image capturing chip including the substrate and an image capturing element including a plurality of light receiving sections for performing a photoelectric conversion on an image light from a subject to capture an image of the subject; and a holder member accommodating a focusing lens for forming an image of an incident light on the image capturing element. In this case, an autofocus control is performed, where the distance between the focus lens and the image capturing element is changed in accordance with the distance to the subject to bring the subject into focus. It is important to accurately form an image of incident light, which originates from a subject, on the image capturing element by the autofocus control in order to obtain a clear image.

Reference 1 discloses how to perform autofocus control as fast as possible in a mode to take a still image of a conventional video camera by extending and shortening a step width for a stepping motor to move within a lens portion. Such a hill climbing method disclosed in the reference and the autofocus control will be described with reference to FIGS. 8 and 9.

FIG. 8 is a flowchart describing the autofocus control of the conventional video camera disclosed in Reference 1.

As illustrated in FIG. 8, when a still image taking mode is selected, an aperture is opened at a step ST101 first. In a step ST102, an electronic shutter is operated. Further, in a step ST103, it is checked whether or not it was in a moving image taking mode and an image was in focus prior to entering the still image taking mode.

When it is a normal start not being in focus in a moving image taking mode, a fast focusing speed is required at a step ST104. In such a case, for example, a moving speed Vs of a focus lens is set to a speed 8Vo, which is eight times faster than the minimum steps, so that the focus lens moves at a fast speed. Further, the intensity of light is measured for a mechanical shutter at a step ST105. At a step ST106, the focus lens is moved. At a step ST107, it is checked whether or not a focal point evaluation value has been decreased for every step ST106. If the focal point evaluation value is decreased at the step ST107, a driving direction is reversed at a step ST108. In a following step ST109, three highest points are stored in a memory of a system control section, where the focal point evaluation values are larger compared to the previous points. At a step ST110, it is checked whether a current location is at a middle point of the three points. If the focal point evaluation value is not at the middle point of the highest points, but at a point at the end, it means that the hill climbing is still continuing and the step goes back to the step ST105 to repeat the process. If the highest point of the focal point evaluation value is at the middle point, it means that the hill climbing has reached about the peak of the hill and a rough location of the peak of the focal point evaluation value can be recognized by this operation.

In a case of a subject where a curve of a focal point evaluation value output illustrated in FIG. 9(a) is obtained, the focus lens begins to move at a point S1 on the focal point evaluation value output curve. A point S4 is at the peak and the focal point value starts to decrease at a following point S5. Therefore, it is recognized that the peak of the focal point evaluation value is at around the point S4, which is the middle of a section between the point S3 and the point S5. The focal point evaluation values and the locations at the three points are recorded in the system control section. At this point, the moving direction of the focus lens is reversed by a stepping motor to the direction towards the point S4 having the peak. Further, it is checked that the speed of the stepping motor is not at the slowest speed Vo at a step ST111, and the speed of the stepping motor is reduced from the speed 8Vo to a speed 4Vo at a step ST112 to move the focus lens to a location of a point S6. In this case, it is recognized that the peak of the focal point evaluation value exists in the vicinity of the point S6, or in the section between the point S4 and the point S5, because the magnitude of the focal point value is defined to be: the point S6>the point S4>the point S5>the point S3. Thus, information on the point S3 and another piece of information on the point S6 are replaced among the previously-recorded three points, and the highest three points are recorded among the focal point evaluation values. This time, the stepping motor is not required to be driven in a reversed direction since the focus lens is at the location of the point S6, which is the center of the three recorded points. Therefore, only the speed is further reduced to a half, speed 2Vo. In the following, the speed is consecutively reduced from 8Vo to 4Vo, 2Vo, and to Vo in a similar manner to sample the focal point value, as illustrated in FIG. 9(b) where the vicinity of the peak of the focal point evaluation value is enlarged.

In a case of a graph in FIG. 9(b), the focal point evaluation value reaches the maximum focusing point once at a point S7. The section exists from the point S4 to the point S6, and the focusing point may lay somewhere in from and behind of the point S7. Therefore, in the end, the speed is reduced to the Vo in order to increase the accuracy of the peak point of the focal point evaluation value at a step ST113. Respective locations of a point S8 to a point S10 are consecutively sampled in such a manner to narrow the moving distance of the focus lens until the speed becomes Vo, so that the interval of the highest three points of the focal point evaluation values are narrowed. Subsequently, a focusing point Ps, where the focal point evaluation value is at its maximum, is obtained and the focus lens is stopped at that point.

As described above, Reference 1 provides a high speed, automatic focusing means based on a focusing operation called the hill climbing method illustrated in FIG. 10. The focus lens is consecutively moved at an arbitrary step from a reference point, and the focal point evaluation value, such as a contrast value, is calculated from image information obtained at every step. When a focal point evaluation value at an arbitrary point is smaller than a focal point evaluation value at the previous step, such a previous step is defined to be a peak point Pf (best focus point) of the focal point evaluation value. The hill climbing method involves a reverse operation taking place from an arbitrary point and a focusing operation to stop at the peak point Pf of the focal point evaluation value. According to Reference 1, the autofocus control is performed at a high speed such that a moving step width in the hill climbing method becomes large when the focus lens is far from the focusing point and the moving step width becomes small when the focus lens is close to the focusing point.

That is, the lens portion consecutively moves by a step moving amount in association with the stepping motor according to Reference 1. Simultaneously with this movement, information on captured image is obtained at every moving step point. Prior to the movement to each step, a focal point evaluation value, such as a contrast value (edge data of black and white), is extracted from the obtained information on the captured image, as data required to focus a certain area of an image. The more accurate the focus is, the higher the focal point evaluation value becomes; and the less accurate the focus is, the lower the focal point evaluation value becomes. When the points are plotted for every step, a kind of a mountain can be drawn as illustrated in FIG. 10. Once, the mountain is searched fully, the search goes back in a reversed direction to where the peak is detected as illustrated with an arrow. The location to go back is defined as a focusing point where the focal point evaluation value is at its maximum.

Reference 1: Japanese Laid-Open Publication No. 7-135596

### SUMMARY OF THE INVENTION

The characteristic of the conventional configuration of Reference 1 described above is such that the peak point Pf of the focal point evaluation value is calculated by a rough step movement, and the focus lens moves to and stops at the peak point Pf of the focal point evaluation value by a slight movement in order to be in focus accurately and in a fast manner.

However, an AF lens unit including a piezoelectric element as a driving portion has the following characteristics. In a case where a piezoelectric element is applied as a driving portion for the autofocus (AF) control by the stepping motor of the characteristic configuration of the conventional Reference 1, each piezoelectric element has a unique characteristic, and the accuracy of the focusing is significantly deteriorated if a piezoelectric element having a significantly different characteristic is used.

As a characteristic of the piezoelectric element, a certain amount of time is required for a moving part to reach a constant speed, as illustrated in FIG. 11. Due to this characteristic, the reproducibility of the step movement cannot be obtained without a constantly same step movement. Besides, the piezoelectric element has hysteresis when the moving direction by the step changes to an orthodox direction and a reverse direction, as illustrated in FIG. 12. In order to obtain the reproducibility, for the moving point, the same step movement needs to be repeated as the first time from the same moving direction. As described above, the piezoelectric element has an outstanding hysteresis characteristic. In the conventional Reference 1 described above where an arbitrary step movement is repeated including a reverse direction movement, the point to make a step movement begins to deviate, and as a result, an accurate reproducibility cannot be obtained and the focus lens cannot be expected to stop at the focusing point correctly.

The present invention is intended to solve the conventional problems described above. The objective of the present invention is to provide a sensor module, which is capable of accurately performing effective autofocus control without deteriorating the accuracy of the focusing as performed conventionally; an autofocus control method of the sensor module; an electronic information device, such as a camera-equipped cell phone device, including the sensor module used as an image input device in an image capturing section; a control program including process steps recorded therein for allowing a computer to execute each step of the autofocus controlling method; and a computer-readable, readable recording medium including the control program stored therein.

A sensor module according to the present invention includes: a lens section for focusing a subject light; an image capturing element where an image of the subject light is formed by the lens section; a driving section for moving the lens section in one direction or a reverse direction close to or away from the image capturing element by driving a piezoelectric element; and an autofocus control section for moving the lens section in a predetermined direction from a reference point to a plurality of predetermined moving points consecutively by the driving section, calculating a focal point evaluation value, which increases as a lens is focused, for every moving point from image information based on an image signal from the image capturing element, obtaining a peak point that corresponds to a peak value of each calculated focal point evaluation value, and subsequently, returning the lens section once to the reference point, and move the lens section in the predetermined direction from the returned reference point to the peak point, thereby achieving the objective described above.

Preferably, in a sensor module according to the present invention, the autofocus control section includes: a first equal interval movement controlling section for instructing the driving section to move the lens section by a predetermined step movement from the reference point to a step point including a peak point of the focal point evaluation value at equal intervals; a focal point evaluation value calculating section for obtaining a focal point evaluation value for every step point; a peak point calculating section for approximating the focal point evaluation value to a predetermined curve using a plurality of points in a vicinity of the peak point to obtain a peak point that corresponds to a peak value; a reference point movement controlling section for instructing the driving section to move the lens section to the reference point; a second equal interval movement controlling section for moving the lens section at once from the reference point to a step point closest to the plurality of points in the vicinity of the peak including the peak point at equal intervals by the same step movement as the step movement by the first equal interval movement controlling section; and a peak point movement controlling section for instructing the driving section to accurately move the lens section by the step movement by changing a driving condition of the piezoelectric element in accordance with a distance from the closest step point to the peak point.

Still preferably, a sensor module according to the present invention further includes a driving wave form outputting section for outputting a driving signal to drive the driving section, where the autofocus control section instructs the driving section via the driving wave form outputting section in order to drive the piezoelectric element and control the step movement of the lens section.

Still preferably, in a sensor module according to the present invention, the reference point is either a lens location corresponding to a subject at an infinity point or a lens location corresponding to the subject at a close-up point.

Still preferably, in a sensor module according to the present invention, an interval between the lens location corresponding to the infinity point and the lens location corresponding to the close-up point is divided into a plurality of equal intervals, and the autofocus control section moves the lens section by a step movement at the equal intervals by the piezoelectric element.

Still preferably, in a sensor module according to the present invention, the autofocus control section further includes a storage section for storing in advance the infinity point or the close-up point as the reference point, and controls the lens section to return to the reference point using the infinity point or the close-up point.

Still preferably, in a sensor module according to the present invention, when the autofocus control section moves the lens section to the reference point, the autofocus control section once returns the lens section to a mechanical end, and subsequently, moves the lens section to the reference point.

Still preferably, in a sensor module according to the present invention, the autofocus control section further includes a storage section for storing in advance the infinity point or the close-up point as the reference point as well as distance information from a location of the mechanical end to the reference point, and controls the lens section to move to the reference point using the infinity point or the close-up point.

Still preferably, in a sensor module according to the present invention, the sensor module stores the each calculated focal point evaluation value in the storage section.

Still preferably, in a sensor module according to the present invention, the distance information to the reference point is a number of pulses of the pulse signal when the driving signal is a pulse signal, and the autofocus control section drives the piezoelectric element for the number of the pulses of the pulse signal to move the lens section to a peak point of the focal point evaluation value.

Still preferably, in a sensor module according to the present invention, the image capturing element includes a plurality of light receiving sections for performing a photoelectric conversion on and capture an image light received via a lens from a subject, the light receiving sections being as a plurality of pixel sections placed in a matrix.

Still preferably, in a sensor module according to the present invention, the predetermined curve is a quadratic curve.

Still preferably, in a sensor module according to the present invention, the predetermined direction is a direction from the reference point to the infinity point or the close-up point.

Still preferably, in a sensor module according to the present invention, the lens section includes a lens for focusing an incident light on the image capturing element, and a lens holder having the lens inserted therein, and the lens holder is movably friction fit to the driving section.

Still preferably, in a sensor module according to the present invention, the lens holder having a lens inserted therein is friction fit to a driving shaft adhered and fixed to the piezoelectric element, and a weight is adhered on the piezoelectric element, and the driving section is configured to be able to move the lens holder along the driving shaft by expansion and contraction driving of the piezoelectric element.

An electronic information device according to the present invention includes the sensor module according to any of claims 1 to 15 used as an image input device in an image capturing section, thereby achieving the objective described above.

An autofocus controlling method according to the present invention for controlling a distance between a lens section and an image capturing element using a piezoelectric element to perform an automatic focusing process includes: an autofocus control step of moving the lens section in a predetermined direction from a reference point to a plurality of predetermined moving points consecutively by a piezoelectric element, calculating a focal point evaluation value, which increases as a lens becomes in focus, for every moving point from image information based on an image signal from the image capturing element, obtaining a peak point that corresponds to a peak value of each calculated focal point evaluation value, and subsequently, returning the lens section once to the reference point, and move the lens section in the predetermined direction from the returned reference point to the peak point, thereby achieving the objective described above.

Preferably, in an autofocus controlling method according to the present invention, the autofocus control step includes: a first equal interval movement controlling step of instructing the driving section to move the lens section by a predetermined step movement from the reference point to a step point including a peak point of the focal point evaluation value at equal intervals; a focal point evaluation value calculating step of obtaining a focal point evaluation value for every step point; a peak point calculating step of approximating the focal point evaluation value to a predetermined curve using a plurality of points in a vicinity of the peak point to obtain a peak point that corresponds to a peak value; a reference point movement controlling step of instructing the piezoelectric element to move the lens section to the reference point; a second equal interval movement controlling step of moving the lens section at once from the reference point to a step point closest to the plurality of points in the vicinity of the peak including the peak point at equal intervals by the same step movement as the step movement by the first equal interval movement controlling step; and a peak point movement controlling step of instructing the driving section to accurately move the lens section by the step movement by changing a driving condition of the piezoelectric element in accordance with a distance from the closest step point to the peak point.

Still preferably, in an autofocus controlling method according to the present invention, the reference point is either a lens location corresponding to a subject at an infinity point or a lens location corresponding to the subject at a close-up point.

Still preferably, in an autofocus controlling method according to the present invention, when the autofocus control step moves the lens section to the reference point, the autofocus control step once returns the lens section to a mechanical end, and subsequently, moves the lens section to the reference point.

A control program according to the present invention includes a process step described therein for allowing a computer to execute each step of the autofocus controlling method according to the present invention, thereby achieving the objective described above.

A readable recording medium according to the present invention, which is computer-readable, includes the control program according to the present invention stored therein, thereby achieving the objective described above.

The functions of the present invention having the structures described above will be described hereinafter.

According to the present invention, the autofocus control section is successively moved to a plurality of predetermined moving points from a reference point in a predetermined direction by a piezoelectric element functioning as a driving section. A focal point evaluation value is calculated for every moving point from image information based on an image signal from an image capturing element, where the focal point evaluation value increases as the focus lens is focused. Subsequent to obtaining a peak point that corresponds to the peak value of the calculated focal point evaluation values, the lens section is once returned to the reference point, and the driving section is controlled to move the lens section in a predetermined direction from the returned reference point to the peak point. As described above, the lens section is returned to the reference point and the positional reproducibility is reset once, and subsequently, the lens section is moved stepwise in the same direction with the same interval. As a result, an effective autofocus control can be performed accurately, without being affected by the unique characteristic of the piezoelectric element and without the deterioration of the accuracy of the focusing as performed conventionally.

In addition, a sensor module including a driving system configured with a piezoelectric element has the following characteristic, and therefore, such a sensor module is effective as an actuator for a portable terminal.

That is, the driving structure is simple and the size of the sensor module can be reduced. In addition, no metal is used for the constituent members of the driving section, so that an influence to an antenna is low in the portable terminal. Further, the driving frequency exceeds the range of audibility, so that a low noise design can be achieved. Further, the autofocus driving can be performed with low power consumption.

According to the present invention as described above, after the lens section is returned to the reference point once and the positional reproducibility is reset, the lens section is moved stepwise in the same direction with the same interval. As a result, an effective autofocus control can be performed accurately, without being affected by the unique characteristic of the piezoelectric element and without the deterioration of the accuracy of the focusing as performed conventionally.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating an exemplary essential hardware structure of an AF lens control unit of a sensor module, which uses a piezoelectric element, according to Embodiment 1 of the present invention.

FIG. 2 is a cross sectional view illustrating an exemplary lens driving mechanism of a sensor module in FIG. 1.

FIG. 3 is a diagram illustrating a location of autofocus control—focus point evaluation value of a sensor module in FIG. 1.

FIG. 4 is a diagram illustrating a focal point evaluation value by example, where FIG. 4(a) is a diagram of an image screen and FIG. 4(b) is a wave form chart illustrating a signal that is a differentiated picture signal from one line in a horizontal direction of an image screen of FIG. 4(a).

FIG. 5 is a flow chart illustrating an operation of an AF lens control unit of a sensor module using a piezoelectric element in FIG. 1.

FIG. 6 is a diagram illustrating AF control of a sensor module using a piezoelectric element in FIG. 1.

FIG. 7 is a block diagram illustrating an exemplary diagrammatic structure of an electronic information device in Embodiment 4 of the present invention, including an AF lens unit according to any of Embodiments 1 to 3 of the present invention used in an image capturing section.

FIG. 8 is a flowchart describing autofocus control of a conventional video camera disclosed in Reference 1.

FIG. 9(a) is a diagram illustrating an exemplary focal point evaluation value output with respect to a point with a curve, with regard to autofocus control of a video camera in FIG. 8; and FIG. 9(b) is an enlarged view of a curve near a peak value of a focal point evaluation value of FIG. 9(a).

FIG. 10 is a diagram illustrating a focusing operation called the hill climbing method using a focal point evaluation value output curve.

FIG. 11 is a diagram illustrating that a moving part of a lens section to move requires a certain amount of time to reach a constant speed in a step movement of a piezoelectric element.

FIG. 12 is a diagram illustrating that a significant hysteresis when a moving direction is different, such as an orthodox direction and a reverse direction, in a step movement by piezoelectric element.

1 lens section
11 lens
12 lens holder
2 image capturing element
3 driving section
31 piezoelectric element
32 driving shaft
33 weight
4 driving wave form outputting section
5 control section
50 autofocus control section
51 first equal interval movement controlling section
52 focal point evaluation value calculating section
53 peak point calculating section
54 reference point movement controlling section
55 second equal interval movement controlling section
56 peak point movement controlling section
6 storage section
10 AF lens control unit
90 electronic information device
91 sensor module
92 memory section
93 display section
94 communication section
95 image output section
Ef peak value
Pf peak point
A, A1, A2 edge data
Ad amplitude
INF infinity point
MCR close-up point (macro point)

### DESCRIPTION OF THE PREFERRED EMBODIMENTS

Hereinafter, a sensor module according to the present invention and an autofocus control method of the sensor module will be described in Embodiments 1 to 3 with reference to the accompanying figures; and an electronic information device including the sensor module used in an image capturing section, as a complete product, will be described in Embodiment 4 with reference to the accompanying figures.

### Embodiment 1

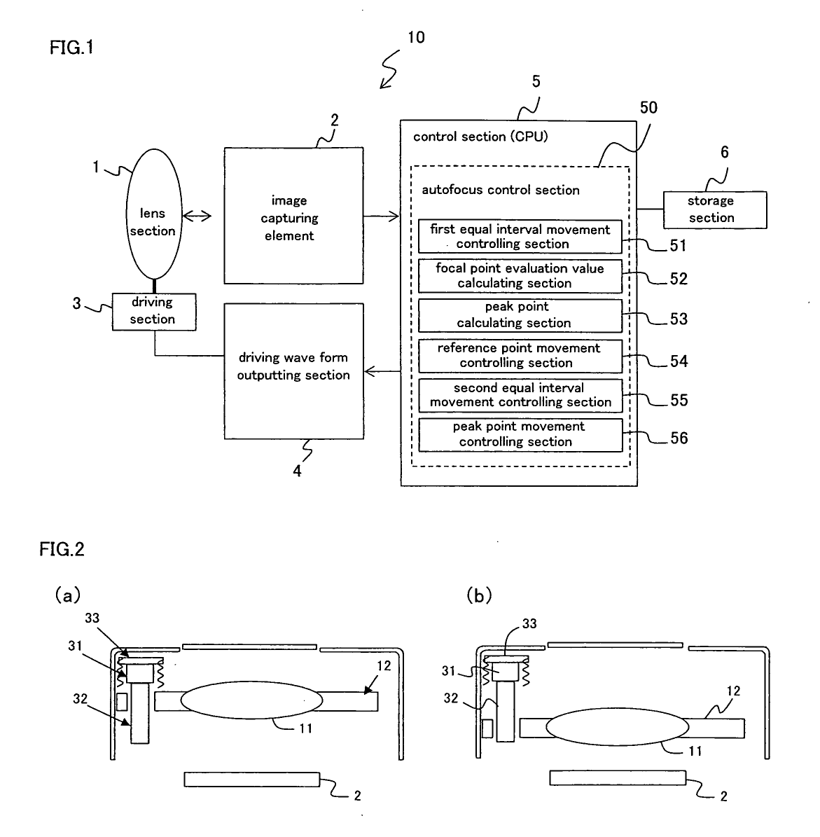

FIG. 1 is a block diagram illustrating an exemplary essential hardware structure of an AF lens control unit of a sensor module, which uses a piezoelectric element, according to Embodiment 1 of the present invention. FIG. 2 is a cross sectional view illustrating an exemplary lens driving mechanism of the sensor module in FIG. 1.

In FIGS. 1 and 2, an AF lens control unit 10 of the sensor module according to Embodiment 1 includes: a movable lens section 1 for focusing a subject light; an image capturing element 2 in which an image of the subject light is formed by the lens section 1; a driving section 3 for driving a piezoelectric element 31, which functions as a piezoelectric actuator that will be described later, to move the lens section 1 in one direction or a reverse direction; a driving wave form outputting section 4 for outputting a predetermined pulse signal of a driving wave form for driving the driving section 3; a control section 5, which is configured with a CPU (central processing unit) for calculating a focal point evaluation value (or an AF integration value), which increases as the focus lens is focused, from image information based on an image signal from the image capturing element 2 to give a predetermined driving instruction to the driving wave form outputting section 4 based on the calculated focal point evaluation value; and a storage section 6 functioning as a readable recording medium for storing a control program for operating the driving section 5 and various kinds of data.

The lens section 1 includes a lens 11 for focusing an incident light on the image capturing element 2; and a vertically movable lens holder 12 including the lens 11 inserted therein. The lens holder 12 is friction fit to a driving shaft 32 (which will be described later) of the driving section 3 so that the lens section 1 is configured to be movable in a direction close to and far away from the image capturing element 2.

The image capturing element 2 is an image capturing chip and includes a plurality of light receiving sections (photodiode or photoelectric conversion element) functioning as a semiconductor element for performing a photoelectric conversion on and capturing an image light received through the lens 11 from a subject. The plurality of light receiving sections are placed as a plurality of pixel sections in a matrix.

In order for the driving section 3 to move the lens section 1, the lens holder 12 including the lens 11 inserted therein is friction fit to the driving shaft 32 adhered and fixed to the piezoelectric element 31. A weight 33 above the piezoelectric element 31 is adhered to the piezoelectric element 31 to determine a stretching direction of the piezoelectric element 31 in one direction. When a pulse signal of a predetermined wave form is provided for the piezoelectric element 31, the piezoelectric element 31 synchronizes to the pulse signal and oscillates minutely. Accordingly, the piezoelectric element 31 vertically moves the lens holder 12 vertically between the distant state with respect to the image capturing element 2 in FIG. 2(a) and a close state with respect to the image capturing element 2 in FIG. 2(b) in order to achieve the autofocus of an incident light in accordance with the distance of the subject.

Although a voice coil motor may be used instead of the stepping motor for the autofocus control, the piezoelectric element 31 is used herein, as described before. With regard to the driving of the piezoelectric element 31, the variation magnitude (amplitude) of the expansion and contraction changes in accordance with a voltage value to be applied, and the speed (variation speed) changes in accordance with a duty ratio of a pulse signal to be given. The structure of the actuator of the piezoelectric element 31 is such that the lens holder 12 of the lens section 1 is friction fit to the driving shaft 32 (carbon rod). When the driving shaft 32 varies at a slow speed, the lens holder 12 moves together with the driving shaft 32 because of the friction fit. When the driving shaft 32 returns to its original state at a high speed, only the driving shaft 32 repeats moving without the effect of the friction fit so that the lens holder 12 moves along the driving shaft 32.

The driving wave form outputting section 4 outputs a predetermined pulse signal as a driving wave form output to the piezoelectric element 31 of the driving section 3. The amplitude, frequency and a signal outputting period (duty ratio) of the pulse signal are controlled based on an instruction signal from the control section 5.

The control section 5 outputs an instruction signal to the driving wave form outputting section 4. The pulse signal from the driving wave form outputting section 4 minutely oscillates the piezoelectric element 31 of the driving section 3 to allow the step movement at a predetermined number of pulses at an arbitral timing with the lens holder 12 including the lens 11 inserted therein as a moving section. In addition, the control section 5 obtains image information from the image capturing element 2 at each step position and calculates a focal point evaluation value, such as a contrast value, based on the image information.

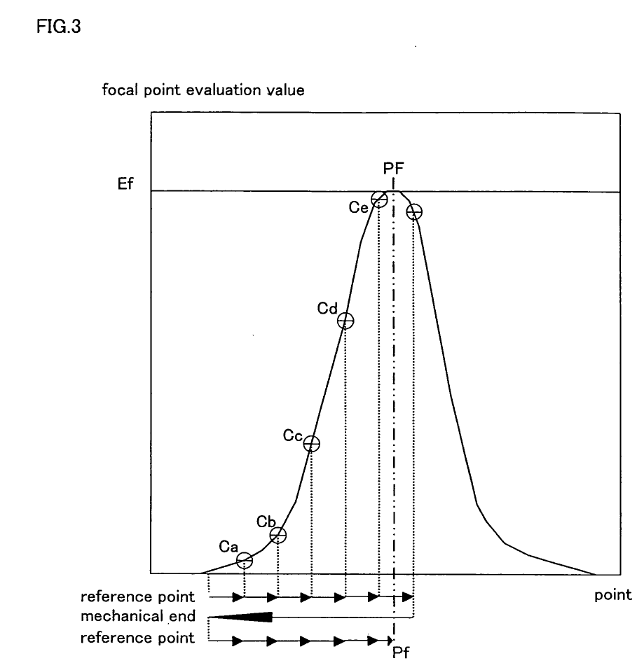

An autofocus control section 50 in the control section 5 includes: a first equal interval movement controlling section 51 for instructing the driving section 3 via the driving wave form outputting section 4 based on a control program in the storage section 6 to allow a predetermined step movement at equal intervals by the hill climbing method to the lens section 1 from a reference point to a point including a peak point Pf, as indicated by an arrow in FIG. 3; a focal point evaluation value calculating section 52 for obtaining a focal point evaluation value for every step position; a peak point calculating section 53 for approximating a focal point evaluation value to a quadratic curve using three points (or a plurality of points such as two points) in the vicinity of a peak to obtain a peak value Ef and a corresponding peak point Pf; a reference point movement controlling section 54 for instructing the driving section 3 via the driving wave form outputting section 4 to return the lens section 1 once to a mechanical end and move the lens section 1 to a reference point; a second equal interval movement controlling section 55 for moving the lens section 1 stepwise all at once from the reference point to a closest step point of the three (or a plural number) points in the vicinity of the peak including the peak point Pf with the same step movement as the original step at equal intervals; and a peak point movement controlling section 56 for instructing the driving section 3 via the driving wave form outputting section 4 to correctly (accurately) move the lens section 3 stepwise to the peak point Pf by changing a driving condition (number of pulses) in accordance with a distance to the peak point Pf for one step to the peak point Pf corresponding to a peak value Ef. Further, the autofocus control section 50 executes various functions.

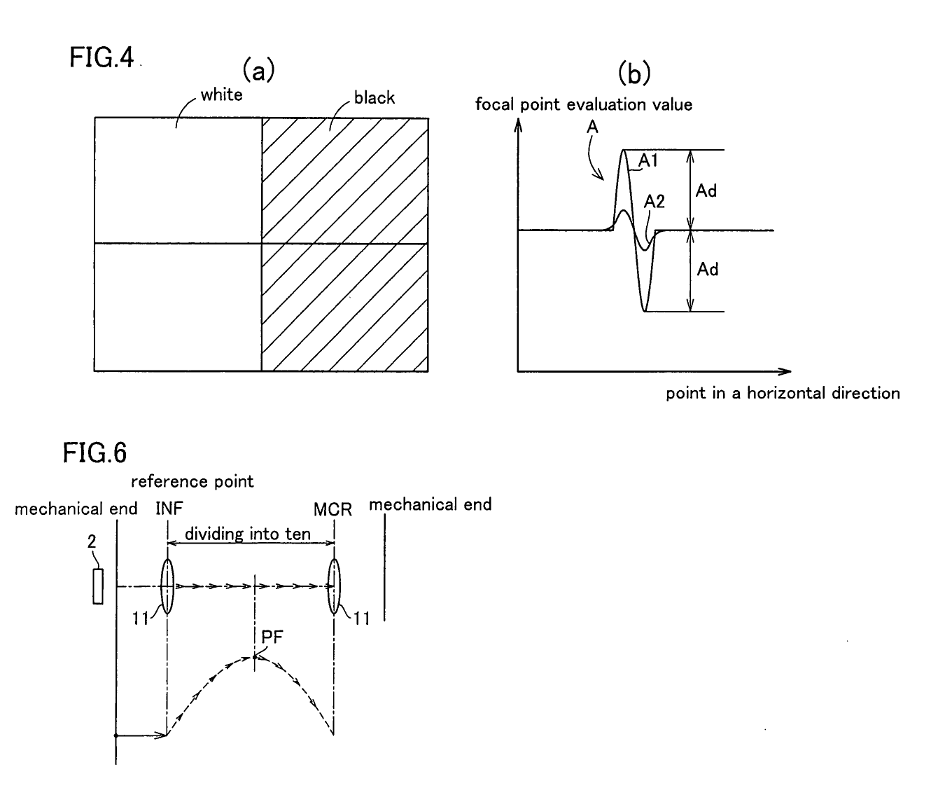

In this case, a focal point evaluation value is something of a contrast value by black and white edge data. For example, a picture of white (left side) and black (right side), as illustrated in FIG. 4(a), is captured and a picture data for one horizontal line is taken from the captured picture. When this picture data is differentiated, a wave form appears as edge data A, as illustrated in FIG. 4(b). As the lens is being focused, the value of the amplitude increases as can be seen by the edge data A1. When the lens is out of focus, the value of the amplitude decreases as can be seen by an edge data A2. With the value of the amplitude Ad as a focal point evaluation value, the peak point Pf corresponding to the largest peak value Ef is obtained.

The storage section 6 stores an infinity point INF and a close-up point MCR (macro point) in advance as part of various kinds of data. Although the infinity point INF is the reference point, the number of pulses from a mechanical end point to the reference point, for example, is also stored in the storage section 6a, the mechanical end being where the lens section 1 is returned once by the drive of the piezoelectric element 31.

The storage section 6 is a ROM or RAM, which is configured of a readable recording medium (storage means), such as a hard disk, an optical disk, a magnetic disk, and an IC memory. This control program and various kinds of data used for the control program may be downloaded from a portable optical disk, magnetic disk, IC memory and the like to a ROM or RAM. Alternatively, the control program and various kinds of data may be downloaded from a computer hard disk to a RAM, or they may be downloaded to a ROM or RAM via radio, cable or the Internet. A control program records process steps for allowing a computer to execute each step of the autofocus control method, and the control program is stored in a readable recording medium, which is computer-readable, thereby achieving the autofocus controlling according to the present invention by a computer (CPU).

With the configuration described above, the autofocus controlling method according to the present invention will be described hereinafter.

FIG. 5 is a flowchart for describing an operation of the AF lens control unit 10 of the sensor module using the piezoelectric element in FIG. 1.

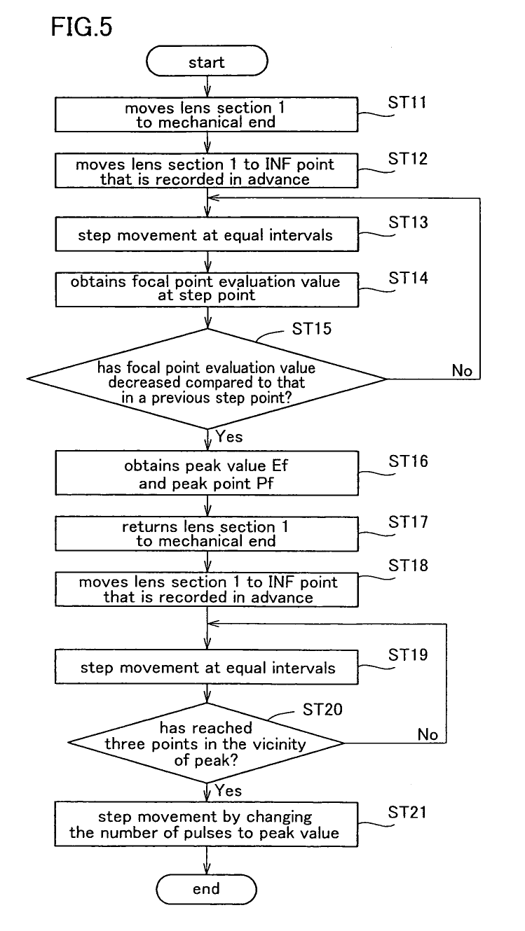

In a step ST11, in order to reset the location of the lens section 1, the control section 5 first instructs the driving wave form outputting section 4 as illustrated in FIG. 5, and the lens section 1 is once moved to a location of a mechanical end on the image capturing element 2 side by the driving of the piezoelectric element 31 by a pulse signal from the driving wave form outputting section 4, as illustrated in FIG. 6.

Next, in a step ST12, the control section 5 instructs the driving wave form outputting section 4, and the lens section 1 is moved from the mechanical end illustrated in FIG. 6 to an INF point illustrated in FIG. 6, which is a reference point recorded in advance in the storage section 6, by the driving of the piezoelectric element 31 by a pulse signal from the driving wave form outputting section 4. An autofocus search range may be divided into arbitrary ranges. Herein, the range between the point INF and the close-up point MCR is divided equally into ten as illustrated in FIG. 6 and the step movement is performed.

Subsequently, in a step ST13, the control section 5 instructs the driving wave form outputting section 4 from the INF point as a reference point, and the lens section 1 is moved stepwise at equal intervals by a pulse signal from the driving wave form outputting section 4.

After the step operation of the lens section 1, a focal point evaluation value Ca illustrated in FIG. 3 is calculated in a step ST14 from a captured image obtained at the step point.

Subsequently, in a step ST15, it is judged whether or not the focal point evaluation value at the step point is calculated as a smaller value than the focal point evaluation value at one previous step point. If the focal point evaluation value at the step point is not smaller than the focal point evaluation value at one previous step point, or if the focal point evaluation value at the step point is an initial focal point evaluation value Ca (NO), it is determined that the hill climbing is in progress and the step returns to the process of the step ST13, where the lens section 1 moves stepwise at equal intervals by a predetermined step movement by a predetermined number of pulses of a pulse signal to obtain the focal point evaluation value (Ca, Cb, Co, Cd, Ce and Cf) for every moving point until the peak point Pf.

Further, if the focal point evaluation value at the step point is smaller than the focal point evaluation value at one previous step point in the step ST15 (YES), the control section 5 instructs the driving wave form outputting section 4 in a step ST16 to stop the driving of the piezoelectric element 31 due to the pulse signal from the driving wave form outputting section 4 and calculate the peak point Pf from the focal point evaluation values Ca, Cb, Cc, Cd, Ce and Cf obtained from each step point by the step movement. In a case of the predetermined curve defined as a quadratic curve, a peak coordinate point is calculated by curve approximation to obtain the peak point. Using the three points in the vicinity of the peak and by approximating to a quadratic curve, a peak value Ef and a corresponding peak point Pf are obtained. From the three points in the vicinity of the peak, three points in the vicinity of the peak including the peak point Pf is obtained, and the three points including the peak point Pf together with the information regarding at which step point the three points are from the reference point, is stored in the storage section 6.

Next, in order to reset the location of the lens section 1, the control section 5 instructs the driving wave form outputting section 4 in a step ST17 to return the lens section 1 once to the location of the mechanical end on the image capturing element 2 side by the driving of the piezoelectric element 31 by the pulse signal from the driving wave form outputting section 4.

Subsequently, the control section 5 instructs the driving wave form outputting section 4 in a step ST18, and the lens section 1 is moved by the driving of the piezoelectric element 31 by the pulse signal from the driving wave form outputting section 4, from the location of the mechanical end to the INF point, which is stored in advance in the storage section 6 as a reference point.

Further, the control section 5 instructs the driving wave form outputting section 4 in a step ST19 from the INF point, which is a reference point, and the lens section 1 is moved stepwise by the driving of the piezoelectric element 31 by the pulse signal from the driving wave form outputting section 4, by the predetermined step movement with the same direction and equal intervals as the first time, as similar to the case in the step ST13.

Further, it is judged in a step ST20 whether or not the step movement of the lens section 1 has been conducted to the closer step point of the two front and back points that include the peak point Pf previously detected and stored in the storage section 6. If the lens section 1 has not completed the step movement to the closest step point of the two front and back points that include the peak point Pf (NO), the step returns to the step of the step ST19 and the hill climbing continues. This judgment is conducted by judging whether the instruction for the step movement has completed up to and including the recorded step point number. Thus, the step movement is conducted at once to the closest step point among the three points that include the peak point Pf.

In addition, if the lens section 1 has completed the step movement to the closest step point of the two front and back points that include the peak point Pf (YES), the driving condition is changed in a step ST21 for the remaining one step to the peak point Pf in accordance with the distance to the peak point Pf. Herein, a driving voltage, a frequency of the pulse signal, and the duty ratio are fixed at the respective predetermined values, and the number of the pulse signals (the number of pulses) are changed in accordance with the distance to the peak point. Thus, the lens section 1 is moved accurately to the peak point Pf of the focusing point to complete the autofocus control.

As described above, the autofocus control method according to the present invention includes: a first equal interval movement controlling step of instructing the piezoelectric element 31 as an autofocus controlling step to allow the lens section 1 to make a predetermined step movement from a reference point at equal intervals to a step point including a peak point of a focal point evaluation value; a focal point evaluation value calculating step of obtaining a focal point evaluation value for every step point; a peak point calculating step of approximating a focal point evaluation value to a predetermined curve using a plurality of points in the vicinity of a peak point so as to obtain a peak point corresponding to a peak value; a reference point movement controlling step of instructing the piezoelectric element 31 to move the lens section 1 to a reference point; a second equal interval movement controlling step of moving the lens section 1 at once to the closest step point of the plurality of points in the vicinity of a peak including a peak point, from a reference point by the same step movement as the step movement in the first equal interval movement controlling step at equal intervals; and a peak point movement controlling step of instructing the piezoelectric element 31 to move the lens section 1 stepwise accurately by changing a driving condition of the piezoelectric element 31 in accordance with a distance from the closest step point to the peak point.

Included in Embodiment 1 as described above, are a first equal interval movement controlling section 51 for instructing the driving section 3 to allow the lens section 1 to make a predetermined step movement from a reference point at equal intervals to a step point including a peak point of a focal point evaluation value; a focal point evaluation value calculating section 52 for obtaining a focal point evaluation value for every step point; a peak point calculating section 53 for approximating a focal point evaluation value to a predetermined curve using a plurality of points in the vicinity of a peak point so as to obtain a peak point corresponding to a peak value; a reference point movement controlling section 54 for instructing the driving section 3 to move the lens section 1 to a reference point; a second equal interval movement controlling section 55 for moving the lens section 1 at once to the closest step point of the plurality of points in the vicinity of a peak including a peak point, from a reference point by the same step movement as the step movement in the first equal interval movement controlling section 51 at equal intervals; and a peak point movement controlling section 56 for instructing the driving section 3 to move the lens section 1 stepwise accurately by changing a driving condition of the piezoelectric element 31 in accordance with a distance from the closest step point to the peak point. As described above, the lens section 1 is once returned to the reference point and the positional reproducibility is reset, and subsequently, the lens section is moved stepwise in the same direction with the same interval. As a result, an autofocus control can be achieved on the basis of the characteristic of the AF lens unit 10 using the piezoelectric element 31 as the driving section 3, thereby achieving an accurate step movement of the lens section 1 to a best focusing point (peak point Pf) of the lens section 1.

### Embodiment 2

In Embodiment 1, in order to reset the location of the lens section 1, the lens section 1 is moved to the location of the mechanical end on the image capturing element 2 side as illustrated in FIG. 6, and further, the lens section 1 is moved from the location of the mechanical end to the INF point, and the lens section 1 is moved stepwise at equal intervals with the INF point as a reference point. In Embodiment 2, in order to reset the location of the lens section 1, the lens section 1 is moved to a location of a mechanical end on the opposite side from the image capturing element 2 side illustrated in FIG. 6, and further, the lens section 1 is moved from the location of the mechanical end to an MCR (macro) point in order for the lens section 1 to make a step movement with the MCR point as a reference point to approach the image capturing element 2 at equal intervals.

Subsequently, the driving section 3 is instructed via the driving wave form outputting section 4, and the lens section 1 is moved by the hill climbing method in an opposite direction from the arrow of FIG. 3 from the reference point to a location including a peak point Pf at a predetermined step movement at equal intervals so as to obtain a focal point evaluation value at every step point. Further, the control section 5 approximates the focal point evaluation value to a quadratic curve using three points in the vicinity of the peak so as to obtain a peak value Ef and a corresponding peak point Pf. Further, the control section 5 instructs the driving section 3 via the driving wave form outputting section 4 to return the lens section 1 once to the mechanical end on the opposite side from the image capturing element 2 side and move the lens section 1 to the reference point (MCR point), and to move the lens section 1 stepwise at once to the three points in the vicinity of the peak including the peak point Pf from the reference point (MCR point) by the same step movement at equal intervals. Further, the control section 5 instructs the driving section 3 via the driving wave form outputting section 4 so as to move the lens section 1 stepwise accurately for one step to the peak point Pf by the driving of the piezoelectric element 31 and by changing the driving condition (the number of pulses) in accordance with the distance.

Also in this case, the lens section 1 is once returned to the reference point and the positional reproducibility is reset, and subsequently, the lens section 1 is moved stepwise in the same direction with the same intervals. As a result, an autofocus control can be achieved on the basis of the characteristic of the AF lens unit 10 using the piezoelectric element 31 as the driving section 3, thereby achieving an accurate step movement of the lens section 1 to a best focusing point (peak point Pf) of the lens section 1.

### Embodiment 3

In Embodiments 1 and 2 described above, in order to reset the location of the lens section 1, the lens section 1 is moved to either location of the mechanical ends, and further, the lens section 1 is moved from the location of the mechanical end to the INF point to move the lens section 1 stepwise at equal intervals with the INF point as a reference point. In Embodiment 3, in order to reset the location of the lens section 1, the lens section 1 is directly moved to either the INF point or MCR point as a reference point, and the lens section 1 moves stepwise from the reference point at equal intervals.

Subsequently, the driving section 3 is instructed via the driving wave form outputting section 4, and the lens section 1 is moved by the hill climbing method in an opposite direction from the arrow of FIG. 3 from the reference point to a location including a peak point Pf at a predetermined step movement at equal intervals so as to obtain a focal point evaluation value at every step point. Further, the control section 5 approximates the focal point evaluation value to a quadratic curve using three points in the vicinity of the peak so as to obtain a peak value Ef and a corresponding peak point Pf. Further, the control section 5 instructs the driving section 3 via the driving wave form outputting section 4 to return the lens section 1 once to the reference point (INF point or MCR point) and move the lens section 1 stepwise at once from the reference point (INF point or MCR point) to the three points in the vicinity of the peak including the peak point Pf by the same step movement as the initial movement at equal intervals. Further, the control section 5 instructs the driving section 3 via the driving wave form outputting section 4 so as to move the lens section 1 stepwise accurately for one step to the peak point Pf by changing the driving condition (the number of pulses) in accordance with the distance and by the driving of the piezoelectric element 31.

Also in this case, the lens section 1 is once returned to the reference point and the positional reproducibility is reset, and subsequently, the lens section 1 is moved stepwise in the same direction with the same intervals. As a result, an autofocus control can be achieved on the basis of the characteristic of the AF lens unit 10 using the piezoelectric element 31 as the driving section 3, thereby achieving an accurate step movement of the lens section 1 to a best focusing point (peak point Pf) of the lens section 1.

### Embodiment 4

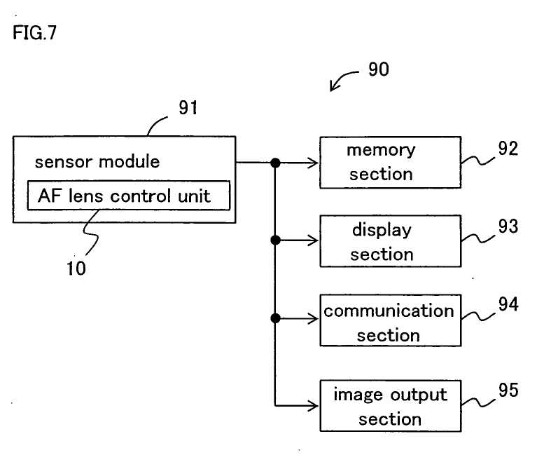

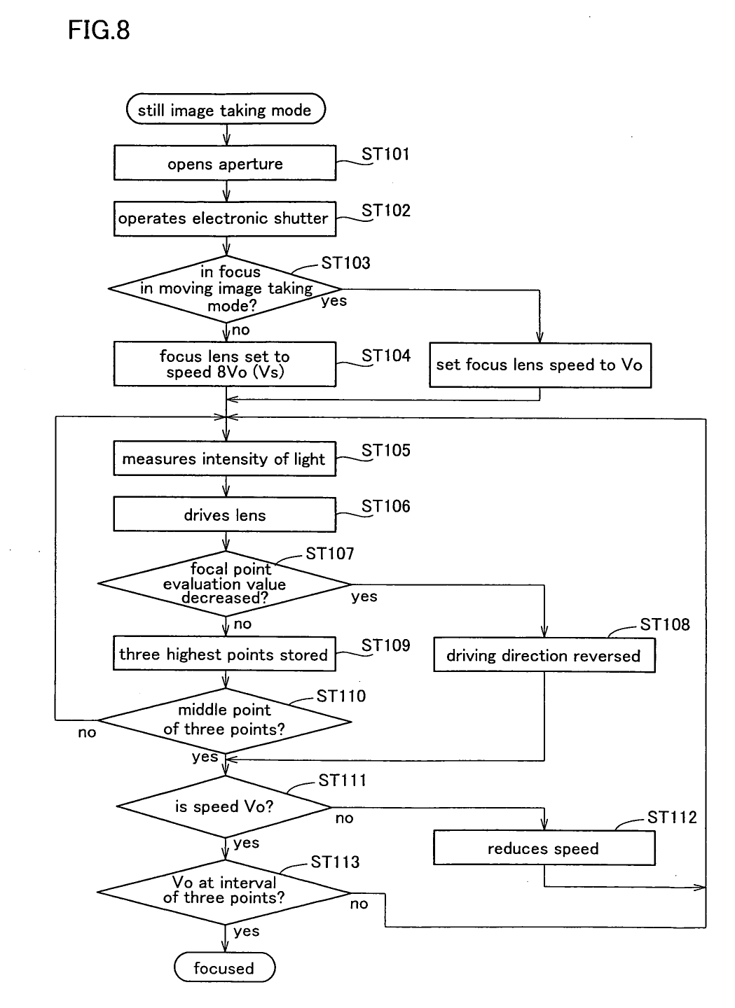

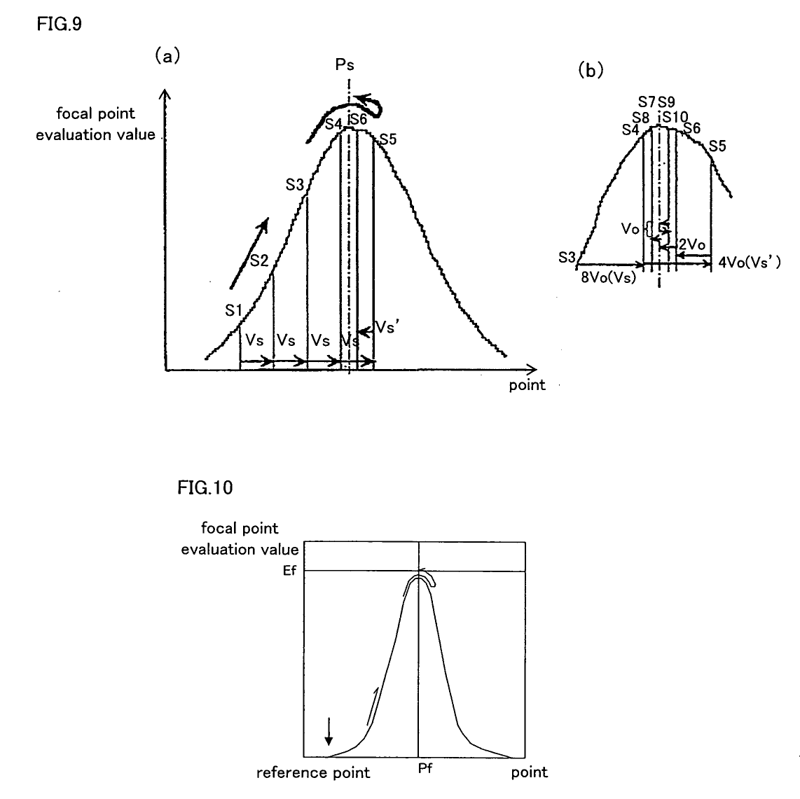

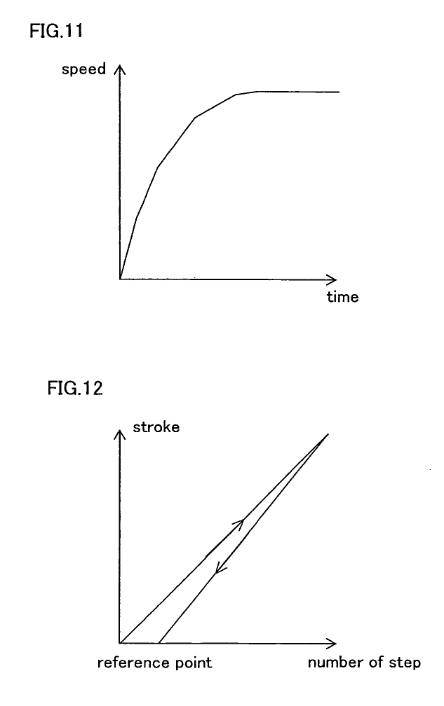

FIG. 7 is a block diagram illustrating an exemplary diagrammatic structure of an electronic information device in Embodiment 4 of the present invention, including the AF lens unit 10 according to any of Embodiments 1 to 3 of the present invention used in an image capturing section.

In FIG. 7, the electronic information device 90 according to Embodiment 4 of the present invention includes: a sensor module 91 for performing various signal processing on an image signal from the AF lens control unit 10 according to any of Embodiments 1 to 3 described above so as to obtain a color image signal; a memory section 92 (e.g., recording media) for data-recording a color image signal from the sensor module 91 after a predetermined signal process is performed on the color image signal for recording; a display section 93 (e.g., a color liquid crystal display apparatus) for displaying the color image signal from the sensor module 91 on a display screen (e.g., liquid crystal display screen) after predetermined signal processing is performed on the color image signal for display; a communication section 94 (e.g., a transmitting and receiving device) for communicating the color image signal from the sensor module 91 after predetermined signal processing is performed on the image signal for communication; and an image output section 95 such as a printer. Without any limitations to this, the electronic information device 90 may include any of the memory section 92, the display section 93, the communication section 94, and the image output apparatus 95.

As the electronic information device 90, an electronic information device that includes an image input device is conceivable, such as a digital camera (e.g., digital video camera and digital still camera), an image input camera (e.g., a monitoring camera, a door phone camera, a camera equipped in a vehicle including a back monitoring camera for vehicle, and a television telephone camera), a scanner, a facsimile machine, a card camera, a camera-equipped cell phone device and a portable digital assistant (PDA).

Therefore, according to Embodiment 4 of the present invention, the color image signal from the sensor module 91 can be: displayed on a display screen finely; printed out on a sheet of paper using an image output section 95; communicated finely as communication data via a wire or a radio; stored finely at the memory section 92 by performing predetermined data compression processing; and further various data processes can be finely performed.

As described above, the present invention is exemplified by the use of its preferred Embodiments 1 to 4. However, the present invention should not be interpreted solely based on Embodiments 1 to 4 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 4 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a sensor module for moving a focusing lens and performing autofocusing to form an image of a subject light on an image capturing chip attached on a substrate; an autofocus controlling method for performing an autofocus control of a focusing lens of the sensor module; an electronic information device, such as a digital camera (e.g., digital video camera and digital still camera), an image input camera (e.g., car-mounted camera, entrance monitoring camera), a scanner, a facsimile machine, a camera-equipped cell phone device, a personal digital assistant (PDA) and a card camera, including the sensor module as an image input device used in an image capturing section of the electronic information device thereof; a control program including process steps recorded therein for allowing a computer to execute each step of the autofocus controlling method; and a readable recording medium, which is computer-readable, including the control program stored therein. According to the present invention, after the lens section is returned to the reference point once and the positional reproducibility is reset, the lens section is moved stepwise in the same direction with the same interval. As a result, an effective autofocus control can be performed accurately, without being affected by the unique characteristic of the piezoelectric element and without the deterioration of the accuracy of the focusing as performed conventionally.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A sensor module, comprising:
a lens section for focusing a subject light;
an image capturing element where an image of the subject light is formed by the lens section;
a driving section for moving the lens section in one direction or a reverse direction close to or away from the image capturing element by driving a piezoelectric element; and
an autofocus control section for moving the lens section in a predetermined direction from a reference point to a plurality of predetermined moving points consecutively by the driving section, calculating a focal point evaluation value, which increases as a lens is focused, for every moving point from image information based on an image signal from the image capturing element, obtaining a peak point that corresponds to a peak value of each calculated focal point evaluation value, and subsequently, returning the lens section once to the reference point, and move the lens section in the predetermined direction from the returned reference point to the peak point.

2. A sensor module according to claim 1, wherein the autofocus control section includes:
a first equal interval movement controlling section for instructing the driving section to move the lens section by a predetermined step movement from the reference point to a step point including a peak point of the focal point evaluation value at equal intervals;
a focal point evaluation value calculating section for obtaining a focal point evaluation value for every step point;
a peak point calculating section for approximating the focal point evaluation value to a predetermined curve using a plurality of points in a vicinity of the peak point to obtain a peak point that corresponds to a peak value;
a reference point movement controlling section for instructing the driving section to move the lens section to the reference point;
a second equal interval movement controlling section for moving the lens section at once from the reference point to a step point closest to the plurality of points in the vicinity of the peak including the peak point at equal intervals by the same step movement as the step movement by the first equal interval movement controlling section; and
a peak point movement controlling section for instructing the driving section to accurately move the lens section by the step movement by changing a driving condition of the piezoelectric element in accordance with a distance from the closest step point to the peak point.

3. A sensor module according to claim 1, further including a driving wave form outputting section for outputting a driving signal to drive the driving section,
wherein the autofocus control section instructs the driving section via the driving wave form outputting section to drive the piezoelectric element and control the step movement of the lens section.

4. A sensor module according to claim 1, wherein the reference point is either a lens location corresponding to a subject at an infinity point or a lens location corresponding to the subject at a close-up point.

5. A sensor module according to claim 4, wherein an interval between the lens location corresponding to the infinity point and the lens location corresponding to the close-up point is divided into a plurality of equal intervals, and the autofocus control section moves the lens section by a step movement at the equal intervals by the piezoelectric element.

6. A sensor module according to claim 4, wherein the autofocus control section further includes a storage section for storing in advance the infinity point or the close-up point as the reference point, and controls the lens section to return to the reference point using the infinity point or the close-up point.

7. A sensor module according to claim 1, wherein, when the autofocus control section moves the lens section to the reference point, the autofocus control section once returns the lens section to a mechanical end, and subsequently, moves the lens section to the reference point.

8. A sensor module according to claim 7, wherein the autofocus control section further includes a storage section for storing in advance the infinity point or the close-up point as the reference point as well as distance information from a location of the mechanical end to the reference point, and controls the lens section to move to the reference point using the infinity point or the close-up point.

9. A sensor module according to claim 5, wherein the sensor module stores the each calculated focal point evaluation value in the storage section.

10. A sensor module according to claim 7, wherein the sensor module stores the each calculated focal point evaluation value in the storage section.

11. A sensor module according to claim 8, wherein the distance information to the reference point is a number of pulses of the pulse signal when the driving signal is a pulse signal, and the autofocus control section drives the piezoelectric element for the number of the pulses of the pulse signal to move the lens section to a peak point of the focal point evaluation value.

12. A sensor module according to claim 1, wherein the image capturing element includes a plurality of light receiving sections for performing a photoelectric conversion on and capture an image light received via a lens from a subject, the light receiving sections being as a plurality of pixel sections placed in a matrix.

13. A sensor module according to claim 2, wherein the predetermined curve is a quadratic curve.

14. A sensor module according to claim 1, wherein the predetermined direction is a direction from the reference point to the infinity point or the close-up point.

15. A sensor module according to claim 1,
wherein the lens section includes a lens for focusing an incident light on the image capturing element, and a lens holder having the lens inserted therein, and
wherein the lens holder is movably friction fit to the driving section.

16. A sensor module according to claim 1,
wherein the lens holder having a lens inserted therein is friction fit to a driving shaft adhered and fixed to the piezoelectric element, and a weight is adhered on the piezoelectric element, and
wherein the driving section is configured to be able to move the lens holder along the driving shaft by expansion and contraction driving of the piezoelectric element.

17. An electronic information device including the sensor module according to claim 1 used as an image input device in an image capturing section.

18. An autofocus controlling method for controlling a distance between a lens section and an image capturing element using a piezoelectric element to perform an automatic focusing process, comprising:
an autofocus control step of moving the lens section in a predetermined direction from a reference point to a plurality of predetermined moving points consecutively by a piezoelectric element, calculating a focal point evaluation value, which increases as a lens becomes in focus, for every moving point from image information based on an image signal from the image capturing element, obtaining a peak point that corresponds to a peak value of each calculated focal point evaluation value, and subsequently, returning the lens section once to the reference point, and move the lens section in the predetermined direction from the returned reference point to the peak point.

19. An autofocus controlling method according to claim 18, wherein the autofocus control step includes:
a first equal interval movement controlling step of instructing the piezoelectric element to move the lens section by a predetermined step movement from the reference point to a step point including a peak point of the focal point evaluation value at equal intervals;
a focal point evaluation value calculating step of obtaining a focal point evaluation value for every step point;
a peak point calculating step of approximating the focal point evaluation value to a predetermined curve using a plurality of points in a vicinity of the peak point to obtain a peak point that corresponds to a peak value;
a reference point movement controlling step of instructing the piezoelectric element to move the lens section to the reference point;
a second equal interval movement controlling step of moving the lens section at once from the reference point to a step point closest to the plurality of points in the vicinity of the peak including the peak point at equal intervals by the same step movement as the step movement by the first equal interval movement controlling step; and
a peak point movement controlling step of instructing the piezoelectric element to accurately move the lens section by the step movement by changing a driving condition of the piezoelectric element in accordance with a distance from the closest step point to the peak point.

20. An autofocus controlling method according to claim 18, wherein the reference point is either a lens location corresponding to a subject at an infinity point or a lens location corresponding to the subject at a close-up point.

21. An autofocus controlling method according to claim 18, wherein, when the autofocus control step moves the lens section to the reference point, the autofocus control step once returns the lens section to a mechanical end, and subsequently, moves the lens section to the reference point.

22. A control program including a process step described therein for allowing a computer to execute each step of the autofocus controlling method according to claim 18.

23. A readable recording medium, which is computer-readable, including the control program according to claim 22 stored therein.
